(19) United States
(12) Patent Application Publication
(10) Pub. No.: US 2024/0022163 A1
(43) Pub. Date: Jan. 18, 2024

(54) DRIVING CIRCUIT, SEMICONDUCTOR DEVICE INCLUDING THE SAME, AND SWITCHING POWER SUPPLY DEVICE INCLUDING THE SAME

(71) Applicant: Rohm Co., Ltd., Kyoto (JP)

(72) Inventors: Yuta SHIROISHI, Kyoto (JP); Takumi FUJIMAKI, Kyoto (JP); Satoru NATE, Kyoto (JP)

(21) Appl. No.: 18/352,592

(22) Filed: Jul. 14, 2023

(30) Foreign Application Priority Data
Jul. 15, 2022 (JP) 2022-114365

(51) Int. Cl. H02M 1/088; H02M 3/335

(52) U.S. Cl. CPC H02M 1/088; H02M 3/33507

(57) ABSTRACT

A driving circuit is configured to be capable of driving a switching element. The driving circuit obtains temperature information of the switching element, and changes driving capability of the switching element based on the temperature information, in at least one of turning on and turning off the switching element.

### CROSS-REFERENCE TO RELATED APPLICATIONS

This nonprovisional application claims priority under 35 U.S.C. § 119(a) on Patent Application No. 2022-114365 filed in Japan on Jul. 15, 2022, the entire contents of which are hereby incorporated by reference.

### BACKGROUND OF THE INVENTION

### Field of the Invention

The present disclosure relates to a driving circuit, a semiconductor device including the same, and a switching power supply device including the same.

### Description of Related Art

Conventionally, a switching element is used in a switching power supply device and a semiconductor device. The switching power supply device turns on and off the switching element, so as to generate a desired output voltage from an input voltage.

Such a switching element causes a loss due to a drain current flowing between drain and source. This loss mainly includes a loss that is constantly generated by an on-resistance in an on-state (hereinafter referred to as an “Ron loss”), a loss that is transiently generated during a switching period from an off-state to the on-state (hereinafter referred to as a “turn-on loss”), and a loss that is transiently generated during a switching period from the on-state to the off-state (hereinafter referred to as a “turn-off loss”).

### SUMMARY OF THE INVENTION

A driving circuit disclosed in this specification, which is a driving circuit configured to be capable of driving a switching element, obtains temperature information of the switching element, and changes driving capability of the switching element based on the temperature information, in at least one of turning on and turning off the switching element.

According to the driving circuit disclosed in this specification, it is possible to suppress increase in loss of the switching element due to temperature increase in the switching element.

### BRIEF DESCRIPTION OF THE DRAWINGS

FIG. 1 is a diagram illustrating a switching power supply according to a first embodiment.

FIG. 2 is a graph illustrating a gate signal, a drain voltage, and a drain current of the switching element according to the first embodiment.

FIG. 3 is a graph illustrating a relationship between temperature of the switching element according to the first embodiment and switching loss in the same.

FIG. 4 is a diagram illustrating the switching power supply according to a second embodiment.

FIG. 5 is a graph illustrating temperature of the switching element of the second embodiment and a slew rate of a gate voltage.

FIG. 6 is a graph illustrating a relationship between temperature of the switching element of the second embodiment and switching loss.

FIG. 7 is a diagram illustrating the switching power supply according to a variation.

FIG. 8 is a diagram illustrating the switching power supply according to another variation.

### DETAILED DESCRIPTION OF THE PREFERRED EMBODIMENTS

In this specification, a metal oxide semiconductor (MOS) field-effect transistor means a field-effect transistor having a gate structure consisting of at least three layers, including a layer of a conductor or semiconductor such as a polysilicon having a small resistance, an insulation layer, and a semiconductor layer of P-type, N-type, or intrinsic semiconductor. In other words, the gate structure of the MOS field-effect transistor is not limited to a three-layer structure of a metal, an oxide, and a semiconductor.

In this specification, constant current means current having a constant value in an ideal state, and in reality it is current that can varies slightly due to temperature variation or the like.

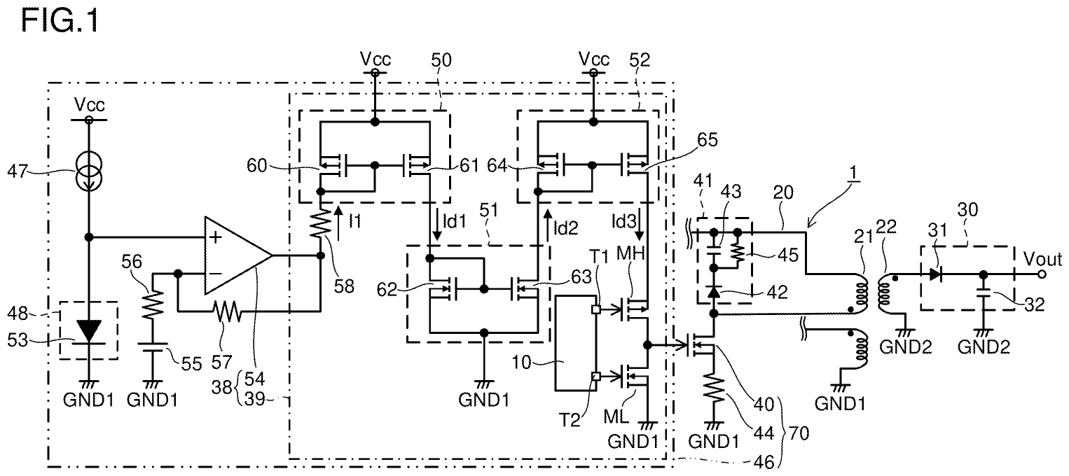

Hereinafter, embodiments are described with reference to the drawings. FIG. 1 is a diagram illustrating a switching power supply 1 according to a first embodiment. The switching power supply 1 of this embodiment is an insulation type flyback power supply. The switching power supply 1 electrically insulates a primary circuit system (GND1 system) from a secondary circuit system (GND2 system), and converts a DC input voltage Vin supplied to the primary circuit system into a desired DC output voltage Vout, so as to output the same from the secondary circuit system. The switching power supply 1 includes a transformer 20, a secondary rectifying/smoothing circuit 30, and a semiconductor device 70.

The transformer 20 includes a primary winding 21 and a secondary winding 22. The primary winding 21 is included in the primary circuit system. The secondary winding 22 is included in the secondary circuit system. The primary winding 21 and the secondary winding 22 electrically insulate the primary circuit system from the secondary circuit system, while they are magnetically coupled to each other.

A first terminal (winding start terminal) of the primary winding 21 is connected to an application terminal of the DC input voltage Vin (not shown). A second terminal (winding end terminal) of the primary winding 21 is connected to a drain of a switching element 40 described later. A first terminal (winding end terminal) of the secondary winding 22 is connected to an input terminal of the secondary rectifying/smoothing circuit 30 (anode of a diode 31 described later). A second terminal (winding start terminal) of the secondary winding 22 is connected to a ground terminal GND2 of the secondary circuit system.

The secondary rectifying/smoothing circuit 30 includes the diode 31 and a capacitor 32 disposed in the secondary circuit system. The secondary rectifying/smoothing circuit 30 rectifies and smooths a voltage induced at the secondary winding 22 of the transformer 20 so as to generate the DC output voltage Vout. The anode of the diode 31 is connected to the first terminal (winding end terminal) of the secondary winding 22. A cathode of the diode 31 and a first terminal of the capacitor 32 are connected to an output terminal of the DC output voltage Vout. A second terminal of the capacitor 32 is connected to the ground terminal GND2 of the secondary circuit system.

The semiconductor device 70 is a switching control IC, which is a main controller of the transformer 20, includes the switching element 40 described later, a resistor 44, and a driving circuit 46.

The switching element 40 is an N-channel type metal oxide semiconductor field effect transistor (MOSFET). The drain of the switching element 40 is connected to the second terminal (winding end terminal) of the primary winding 21 and to an input terminal of a snubber circuit 41 (anode of a diode 42 described later). A source of the switching element 40 is connected to a ground terminal GND1 of the primary circuit system via the resistor 44. Agate of the switching element 40 is connected to the driving circuit 46 described later.

The switching element 40 makes and breaks a current path from the application terminal of the DC input voltage Vin through the primary winding 21 of the transformer 20 to the ground terminal GND1 of the primary circuit system, in accordance with a gate signal G1 (gate voltage) applied to the gate, so as to turn on and off a primary current Ip flowing in the primary winding 21. The switching element 40 is turned on when the gate signal G1 is at high level, and is turned off when the gate signal G1 is at low level.

The snubber circuit 41 includes the diode 42, a capacitor 43, and a resistor 45, which are disposed in the primary circuit system. The snubber circuit 41 is a protection circuit that absorbs a transient surge voltage generated at the primary winding 21. A first terminal of the capacitor 43 is connected to a cathode of the diode 42. A second terminal of the capacitor 43 is connected to the first terminal (winding start terminal) of the primary winding 21 and to the application terminal of the DC input voltage Vin (not shown). A first terminal of the resistor 45 is connected to the first terminal of the capacitor 43 and to the cathode of the diode 42. A second terminal of the resistor 45 is connected to the second terminal of the capacitor 43.

The driving circuit 46 is connected to the gate of the switching element 40, and is configured to be capable of driving the switching element 40. The driving circuit 46 obtains temperature information of the switching element 40 (such as information corresponding to ambient temperature of the switching element 40 having correlation with junction temperature of the switching element 40), and changes a gradient (rise time) of the gate signal G1 on the basis of the temperature information, so as to change driving capability of the switching element 40. Hereinafter, the driving circuit 46 is described in detail.

The driving circuit 46 includes a current source 47, a temperature monitor 48, and an output section 38. The temperature monitor 48 can obtain temperature information of the switching element 40. The output section 38 generates the predetermined gate signal G1 based on the obtained temperature information and outputs the same to the gate of the switching element 40.

The temperature monitor 48 in this embodiment is a diode 53 having a temperature characteristic in which its forward voltage decreases along with temperature increase. The diode 53 is placed relatively close to the switching element 40, and its temperature rises when being heated by the switching element 40. The temperature information according to this embodiment is the voltage value of the forward voltage that changes according to ambient temperature of the switching element 40. An anode of the diode 53 is connected to the current source 47. A cathode of the diode 53 is connected to the ground terminal GND1.

The output section 38 includes an operational amplifier 54 and an adjusting section 39. The operational amplifier 54 is an op amp having a negative terminal (first terminal), a positive terminal (second terminal), and an output terminal. The positive terminal of the operational amplifier 54 is connected to the anode of the diode 53 and to an output terminal of the current source 47. The negative terminal of the operational amplifier 54 is connected to the ground terminal GND1 via a resistor 56 and an internal power supply 55. In addition, the negative terminal of the operational amplifier 54 is connected to an output terminal of the operational amplifier 54 via a resistor 57.

The output terminal of the operational amplifier 54 is connected to an input terminal of the adjusting section 39 (a drain of a transistor 60 described later) via a resistor 58. The operational amplifier 54 amplifies a difference between a voltage value applied to the negative terminal and a voltage value applied to the positive terminal by a predetermined amplification factor to be an output voltage, and applies the output voltage to the resistor 58.

The forward voltage of the diode 53 is denoted by VF, a voltage value of the internal power supply 55 is denoted by V1, a voltage value of the output terminal of the operational amplifier 54 is denoted by V2, a voltage value at a terminal of the resistor 58 on the side of a first current mirror 50 is denoted by V3, a resistance of the resistor 56 is denoted by R1, a resistance of the resistor 57 is denoted by R2, and a resistance of the resistor 58 is denoted by R3. Then, the following relationships of equations (1) and (2) are satisfied.

$${V}_{2} = {V}_{F} - \frac{{R}_{2}}{{R}_{1}} ( {V}_{1} - {V}_{F} ) \qquad ( 1 )$$

$${I}_{1} = \frac{( {V}_{3} - {V}_{2} )}{{R}_{3}} \qquad ( 2 )$$

An output terminal of the adjusting section 39 (connection node between a drain of a high-side transistor MH described later and a drain of a low-side transistor ML described later) is connected to the gate of the switching element 40. The adjusting section 39 changes the gradient (rise time) of the gate signal G1 on the basis of the output voltage of the operational amplifier 54.

The adjusting section 39 includes the first current mirror 50, a second current mirror 51, a third current mirror 52, the high-side transistor MH, the low-side transistor ML, and a signal control section 10. The low-side transistor ML is a N-channel type MOSFET. The high-side transistor MH is a P-channel type MOSFET.

The first current mirror 50 includes the transistor 60 and a transistor 61. The transistors 60 and 61 are P-channel type MOSFETs. Gates of the transistors 60 and 61 are connected to a drain of the transistor 60. As described above, the drain of the transistor 60 is connected to the output terminal of the operational amplifier 54. A source of the transistor 60 and a source of the transistor 61 are connected to a power supply voltage Vcc. A drain of the transistor 61 is connected to an input terminal of the second current mirror 51 (drain of a transistor 62 described later).

The first current mirror 50 mirrors a current I1 flowing in the resistor 58 at a predetermined mirror ratio, so as to output a mirror current Id1 from the drain of the transistor 61.

The second current mirror 51 includes the transistor 62 and a transistor 63. The transistors 62 and 63 are N-channel type MOSFETs. Gates of the transistors 62 and 63 are connected to a drain of the transistor 62. Sources of the transistors 62 and 63 are connected to the ground terminal GND1. A drain of the transistor 63 is connected to an input terminal of the third current mirror 52 (drain of a transistor 64 described later).

The second current mirror 51 mirrors the mirror current Id1 output from the transistor 61 at a predetermined mirror ratio, so as to output a mirror current Id2 from the drain of the transistor 63.

The third current mirror 52 includes the transistor 64 and a transistor 65. The transistors 64 and 65 are P-channel type MOSFETs. Gates of the transistors 64 and 65 are connected to the drain of the transistor 64. A source of the transistor 64 and a source of the transistor 65 are connected to the power supply voltage Vcc. A drain of the transistor 65 is connected to a source of the high-side transistor MH.

The third current mirror 52 mirrors the mirror current Id2 output from the transistor 63 at a predetermined mirror ratio, so as to output a mirror current Id3 from the drain of the transistor 65.

A drain of the high-side transistor MH and a drain of the low-side transistor ML are connected to the gate of the switching element 40. A source of the low-side transistor ML is connected to the ground terminal GND1.

A gate of the high-side transistor MH is connected to an external terminal T1 of the signal control section 10. A gate of the low-side transistor ML is connected to an external terminal T2 of the signal control section 10.

The signal control section 10 is a switching control IC that is a main controller of the transformer 20. The signal control section 10 generates gate signals of the high-side transistor NM and the low-side transistor ML, respectively. The high-side transistor NM generates the gate signal G1 at high level, while the low-side transistor ML generates the gate signal G1 at low level.

Next, changing of driving capability of the switching element 40 by the driving circuit 46 is described in detail. When temperature of the switching element 40 rises so that ambient temperature of the switching element 40 rises, temperature of the diode 53 also rises. When temperature of the diode 53 rises, the forward voltage of the diode 53 is lowered.

As described above, when temperature of the diode 53 rises due to the temperature rise of the switching element 40, the forward voltage thereof is lowered. When the forward voltage VF is lowered, the output voltage V2 of the operational amplifier 54 is lowered according to the above equation (1). When the output voltage V2 is lowered, the current I1 flowing in the resistor 58 is increased according to the above equation (2).

Then, the mirror current Id3 is also increased, which flows into the high-side transistor NM via the first to third current mirrors 50 to 52. Along with the increase in the mirror current Id3, the rise time of the gate signal G1 at low level is shortened. In this way, the driving circuit 46 obtains the temperature information of the switching element 40, and changes the gradient (rise time) of the gate signal G1 of the switching element 40 in accordance with the temperature information.

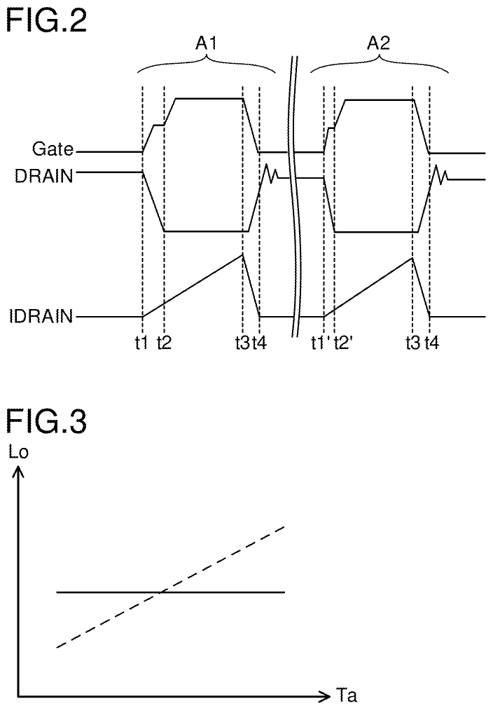

FIG. 2 is a graph illustrating the gate signal G1 (Gate), a drain voltage (DRAIN), and a drain current (IDRAIN) of the switching element 40 according to this embodiment. The left side of the graph (the partA1 in FIG. 2) is a graph of the switching element of the switching power supply without the temperature monitor 48 and the output section 38 (hereinafter referred to as a “reference example”). The right side of the graph (the part A2 in FIG. 2) is a graph of the switching element 40 of the switching power supply 1 having the driving circuit 46 of this embodiment.

The switching element 40 of the reference example has the gate signal G1 at low level in the off-state (during the period until time t1). Further, when it is switched from off-state to on-state (during the period from time t1 to time t2), a voltage value of the gate signal G1 rises from low level to high level. When the voltage value of the gate signal G1 rises, the drain voltage is lowered, and the drain current increases. A power (loss) generated during this period is the turn-on loss.

In the switching element 40 of the reference example, the gate signal G1 reaches high level and maintains the level during the period from time t2 to time t3.

When the switching element 40 of the reference example is switched from on-state to off-state (during the period from time t3 to time t4), the gate signal G1 is lowered from high level to low level. At this time, while the voltage value of the gate signal G1 is lowered, the drain voltage rises, and the drain current decreases. The power (loss) generated during this period is the turn-off loss.

On the other hand, the switching power supply 1 of this embodiment adopts the structure as described above, in which the driving circuit 46 obtains temperature information of the switching element 40, and changes the gradient of the gate signal G1 of the switching element 40 based on the temperature information. Therefore, when the switching element 40 is switched from off-state to on-state (during the period from time t1′ to time t2′), the rise time of the gate signal G1 is shorter than that in the reference example. In other words, the time interval for the gate signal G1 to rise from low level to high level (the period from time t1′ to time t2′) is shorter than that in the reference example (the period from time t1 to time t2). Therefore, the power loss (turn-on loss) of the switching element 40 in this embodiment, which is generated when it is turned on, is smaller than that in the reference example.

FIG. 3 is a graph illustrating a relationship between temperature (Ta) of the switching element 40 according to this embodiment and a loss (Lo) in the switching element 40. In the graph, a broken line indicates the switching loss in the switching element 40 of the reference example, while a solid line indicates the switching loss in the switching element 40 of this embodiment. The switching loss is calculated as the sum of the Ron loss, the turn-on loss, and the turn-off loss.

As described above, the Ron loss increases along with temperature increase of the switching element 40. Therefore, as illustrated in FIG. 3, in the switching element 40 of the reference example, the loss of the switching element 40 increases in proportion with the temperature increase. On the other hand, in the switching element 40 of this embodiment, even if the Ron loss increases due to the temperature increase of the switching element 40, the turn-on loss decreases to offset the increase in the Ron loss as described above. Therefore, as illustrated in FIG. 3, even if temperature of the switching element 40 increases, it is possible to suppress the increase in loss in the switching element 40.

Therefore, by adopting the driving circuit 46 of the above embodiment, it is possible to suppress increase in loss in the switching element 40 due to temperature increase of the switching element 40.

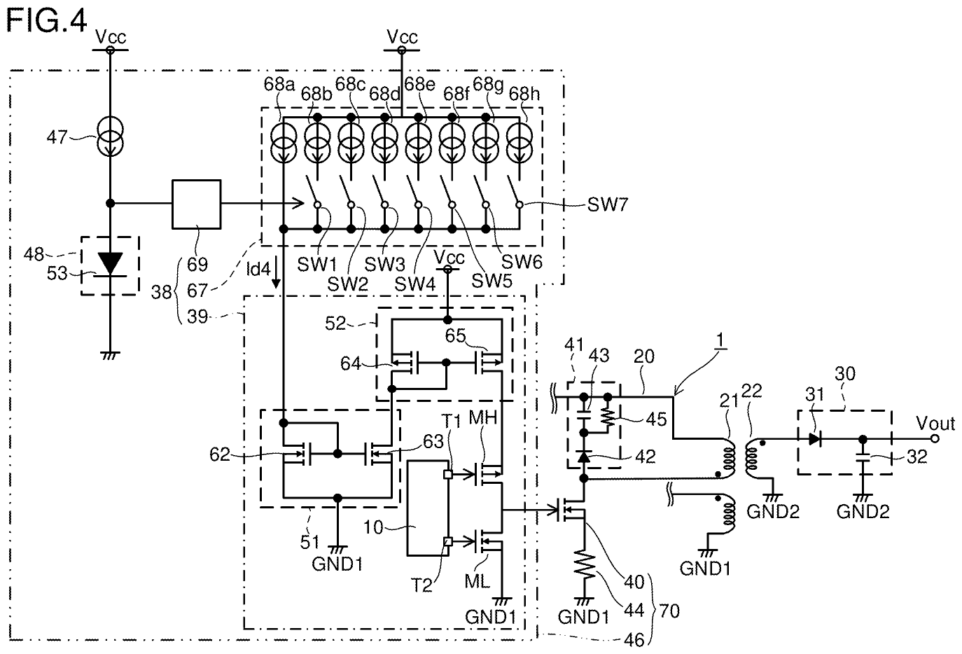

Next, the switching power supply 1 of a second embodiment is described. Note that in the following description, a difference to the first embodiment is described, and the same structure as the first embodiment is denoted by the same numeral or symbol so that description thereof is omitted. FIG. 4 is a diagram illustrating the switching power supply 1 according to the second embodiment.

The output section 38 of the switching power supply 1 of this embodiment includes a variable current source 67, a selector 69 (control section), and the adjusting section 39.

The variable current source 67 includes a plurality of constant current sources 68a to 68h, and switch terminals SW1 to SW7. The constant current sources 68a to 68h are connected to the power supply voltage Vcc. The constant current source 68a is connected to the drain of the transistor 62 of the second current mirror 51.

Output terminals of the switch terminals SW1 to SW7 are connected to the drain of the transistor 62. The constant current sources 68b to 68h are arranged to be capable of connecting or disconnecting with the drain of the transistor 63 via the switch terminals SW1 to SW7, respectively.

The selector 69 is connected to the anode of the diode 53. The selector 69 selects a connection state or a disconnection state of each of the switch terminals SW1 to SW7 on the basis of temperature information obtained by the diode 53.

Specifically, the selector 69 beforehand stores patterns of the connection state or the disconnection state of each of the switch terminals SW1 to SW7 according to the voltage value of the forward voltage of the diode 53. When the forward voltage of the diode 53 is applied to the selector 69, the connection state or the disconnection state of each of the switch terminals SW1 to SW7 is selected on the basis of the voltage value of the forward voltage. At this time, the selector 69 selects the connection state of the switch terminals SW1 to SW7 one by one along with decrease in the forward voltage by a predetermined value.

The variable current source 67 outputs a drain current Id4 to the drain of the transistor 62. A current value of the drain current Id4 is the sum of current values of constant current sources in the connection state out of the constant current sources 68b to 68h and a current value of the constant current source 68a. The drain current Id4 flows into the drain of the high-side transistor MH as a predetermined drain current via the second current mirror 51 and the third current mirror 52. Note that sources of the transistor 62 and the transistor 63 of the second current mirror 51 are connected to the ground terminal GND1.

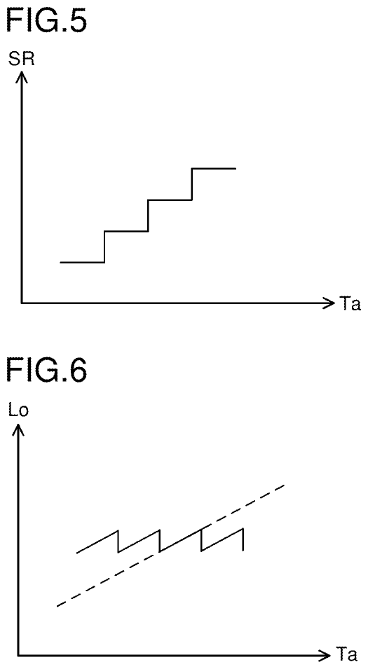

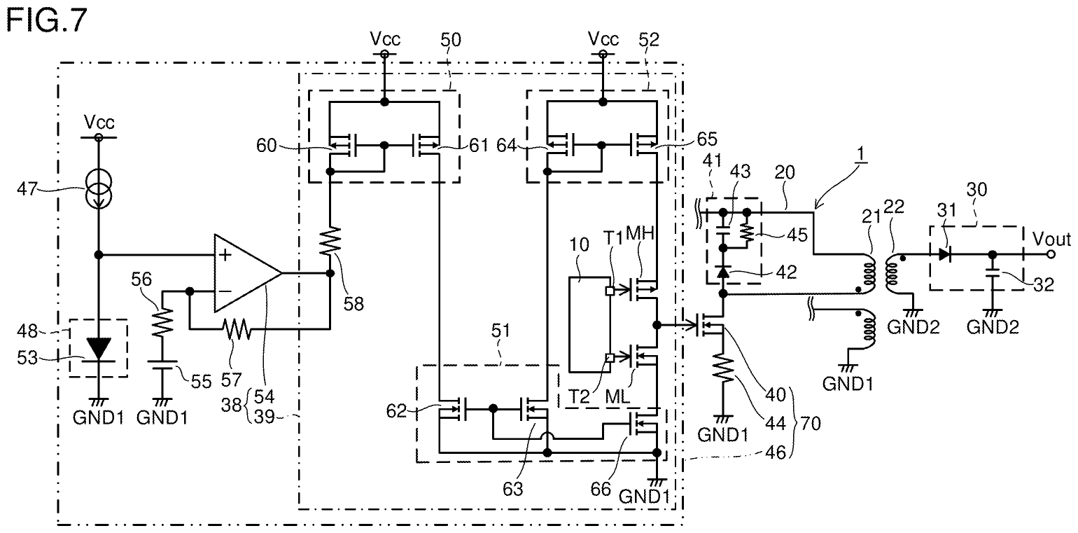

FIG. 5 is a graph illustrating temperature (Ta) of the switching element 40 of this embodiment and a slew rate (SR) of the gate signal G1. FIG. 6 is a graph illustrating a relationship between temperature (Ta) of the switching element 40 of this embodiment and loss (Lo) in the switching element 40. In the graph of FIG. 6, a broken line indicates the loss in the switching element 40 of the reference example described above, while a solid line indicates the loss in the switching element 40 of this embodiment.

When temperature of the switching element 40 rises so that temperature of the diode 53 rises, the forward voltage of the diode 53 is lowered. Then, as described above, the drain current Id4 output from the variable current source 67 rises step by step. As a result, as illustrated in FIG. 5, the slew rate of the switching element 40 increases along with temperature increase thereof, and the turn-on loss can be decreased. In this way, as illustrated in FIG. 6, even if temperature of the switching element 40 increases, increase in the loss in the switching element 40 can be suppressed.

Note that, other than the embodiments described above, the structure of the present disclosure can be variously modified within the scope of the present disclosure without deviating from the spirit thereof.

For instance, the embodiments described above adopt the structure in which driving capability of the switching element 40 is changed only when the switching element 40 is turned on, but it may be possible to adopt a structure in which the driving capability is changed also when the switching element 40 is turned off.

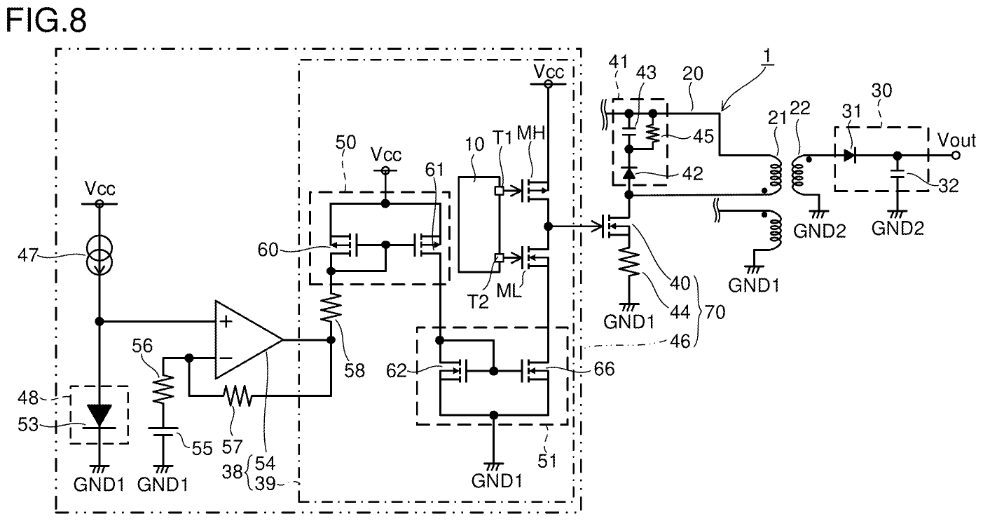

In this case, as illustrated in FIG. 7, the second current mirror 51 includes a transistor 66. A drain of the transistor 66 is connected to a source of the low-side transistor 63. A source of the transistor 66 is connected to the ground terminal GND1. A source of the transistor 63 is connected to the source of the transistor 66. In addition, gates of the transistor 62 and the transistor 63 are connected to a gate of the transistor 66. In this way, not only the turn-on loss but also the turn-off loss can be reduced, and increase in the loss in the switching element 40 due to temperature increase of the switching element 40 can be suppressed more effectively.

In addition, it may also be possible to adopt a structure in which driving capability of the switching element 40 is changed only when the switching element is turned off. In this case, as illustrated in FIG. 8, the second current mirror 51 includes the transistor 62 and the transistor 66. The drain of the transistor 66 is connected to the source of the low-side transistor ML.

The driving circuit (46) disclosed in the specification, which is a driving circuit configured to be capable of driving a switching element (40), obtains temperature information of the switching element (40), and changes driving capability of the switching element (40) based on the temperature information, in at least one of turning on and turning off the switching element (40) (first structure).

Note that in the driving circuit (46) having the first structure, it is preferred to adopt a structure including a temperature monitor (48) that obtains the temperature information, and an output section (38) that applies the switching element (40) with a gate voltage (G1) changing with gradient corresponding to the temperature information obtained by the temperature monitor (48) (second structure).

In addition, in the driving circuit (46) having the second structure, it is preferred to adopt a structure in which the temperature monitor (48) includes a diode (42) that has a forward voltage changing depending on temperature, and outputs the forward voltage or a voltage corresponding to the forward voltage as the temperature information (third structure).

In addition, in the driving circuit (46) having the third structure, it is preferred to adopt a structure in which the output section (38) includes an operational amplifier having a first terminal connected to the diode (42), a second terminal applied with a predetermined voltage, and an output terminal that outputs an output voltage obtained by amplifying a difference between potentials at the first terminal and the second terminal by a predetermined amplification factor; and an adjusting section (39) connected between the output terminal and the switching element (40), so as to change a gradient of the gate voltage (G1) based on a voltage value of the output voltage (fourth structure).

In addition, in the driving circuit (46) having the third structure, it is preferred to adopt a structure in which the output section (38) includes a variable current source (67) that has a plurality of constant current sources (68a to 68h) outputting a predetermined constant current or cutting off the current, and outputs an output current corresponding to the sum of current values of constant current sources in the outputting state out of the constant current sources (68a to 68h); a control section (69) that selects the outputting state or the cutting-off state of each of the constant current sources (68a to 68h) based on a voltage value of the forward voltage; and an adjusting section (39) that changes the gradient of the gate voltage (G1) based on a current value of the output current (fifth structure).

In addition, the semiconductor device (70) disclosed in the specification includes the switching element (40) and the driving circuit (46) having any one of the first to fifth structures (sixth structure).

In addition, the switching power supply device (1) disclosed in the specification includes the switching element (40) and the driving circuit (46) having any one of the first to fifth structures (seventh structure).

According to the driving circuit (46) having the first structure, it is possible to suppress increase in loss in the switching element (40) due to temperature increase of the switching element 40.

In addition, according to the driving circuit (46) having the second structure, driving capability of the switching element (40) can be changed more appropriately according to temperature information of the switching element (40) obtained by the temperature monitor (48).

In addition, according to the driving circuit (46) having the third structure, temperature information of the switching element (40) can be obtained based on change in the forward voltage of the diode (42). In this way, driving capability of the switching element (40) can be changed more appropriately according to temperature information.

In addition, according to the driving circuit (46) having the fourth structure, it is possible to realize the structure in which driving capability of the switching element (40) is changed according to change in the forward voltage of the diode (42). Therefore, without providing a complicated control system, driving capability of the switching element (40) can be changed more appropriately.

In addition, according to the driving circuit (46) having the fifth structure, driving capability of the switching element (40) can be changed step by step according to temperature information.

In addition, according to the semiconductor device (70) having the sixth structure, it is possible to provide the semiconductor device (70) that can suppress increase in loss in the switching element (40) due to temperature increase of the switching element (40).

In addition, according to the switching power supply device (1) having the seventh structure, it is possible to provide the switching power supply device (1) that can suppress increase in loss in the switching element (40) due to temperature increase of the switching element (40).

The present disclosure can be utilized for switching power supply devices used in all fields (such as home appliance field, automobile field, and industrial machinery field).

What is claimed is:

1. A driving circuit configured to be capable of driving a switching element, wherein the driving circuit obtains temperature information of the switching element, and changes driving capability of the switching element based on the temperature information, in at least one of turning on and turning off the switching element.

2. The driving circuit according to claim 1, comprising:
a temperature monitor that obtains the temperature information; and
an output section that applies the switching element with a gate voltage changing with gradient corresponding to the temperature information obtained by the temperature monitor.

3. The driving circuit according to claim 2, wherein the temperature monitor includes a diode that has a forward voltage changing depending on temperature, and outputs the forward voltage or a voltage corresponding to the forward voltage as the temperature information.

4. The driving circuit according to claim 3, wherein the output section includes:
an operational amplifier having a first terminal connected to the diode, a second terminal applied with a predetermined voltage, and an output terminal that outputs an output voltage obtained by amplifying a difference between potentials at the first terminal and the second terminal by a predetermined amplification factor; and
an adjusting section connected between the output terminal and the switching element, so as to change a gradient of the gate voltage based on a voltage value of the output voltage.

5. The driving circuit according to claim 3, wherein the output section includes:
a variable current source that has a plurality of constant current sources outputting a predetermined constant current or cutting off the current, and outputs an output current corresponding to the sum of current values of constant current sources in the outputting state out of the constant current sources;
a control section that selects the outputting state or the cutting-off state of each of the constant current sources based on a voltage value of the forward voltage; and
an adjusting section that changes the gradient of the gate voltage based on a current value of the output current.

6. A semiconductor device comprising:
the driving circuit according to claim 1; and
the switching element.

7. A switching power supply device comprising:
the driving circuit according to claim 1; and
the switching element.
